(19) United States
(12) Patent Application Publication
(10) Pub. No.: US 2010/0188940 A1
(43) Pub. Date: Jul. 29, 2010

(54) Clock

(76) Inventor: Ricardo A. Tello, Santa Fe Springs, CA (US)

Correspondence Address: Steven E. Shapiro, 1223 Wilshire Blvd., #461, Santa Monica, CA, 90403, US

(21) Appl. No.: 12/655,969

(22) Filed: Jan. 11, 2010

Related U.S. Application Data
(60) Provisional application No. 61/204,775, filed on Jan. 9, 2009.
(60) Provisional application No. 61/204,923, filed on Jan. 13, 2009.

(51) Int. Cl. G04B 37/00

(52) U.S. Cl. 368/309

(57) ABSTRACT

The present invention is a wall clock with a clock face; a clear domed cover over the clock face, wherein the clear domed cover has a flat surface at the center to serve as a branding area. The wall clock preferably has a label covering substantially all of said flat surface. The label itself can be covered by a clear dome, such as an epoxy dome. Typically, the flat surface is circular. Preferably, the flat surface is sunken into the top surface of the clear domed cover that covers the face of the clock.

### CROSS-REFERENCE TO RELATED APPLICATIONS

The applicant hereby claims benefit of U.S. Provisional Patent Application No. 61/204,775 (filed Jan. 9, 2009). The specification of said provisional patent application is incorporated herein by this reference as though set forth in full.

The applicant hereby claims benefit of U.S. Provisional Patent Application No. 61/204,923 (filed Jan. 13, 2009). The specification of said provisional patent application is incorporated herein by this reference as though set forth in full.

### STATEMENT REGARDING FEDERALLY SPONSORED RESEARCH OR DEVELOPMENT

Not Applicable

### FIELD OF INVENTION

The present invention relates to clocks. In particular, the present invention relates to wall clocks used for advertising.

### BACKGROUND OF THE INVENTION

Wall clocks are often used for advertising. Typically, the branding is on the face of the clock. The present invention is uniquely configured so that branding can be placed prominently on the clock, face cover, as opposed to the face of the clock.

### SUMMARY OF THE INVENTION

The present invention is a wall clock that has a clock face, a clear domed cover over the clock face, wherein the clear domed cover has a flat surface at the center to serve as a branding area. The wall clock generally has a label that covers substantially the entire flat surface and the label itself can be covered by a clear dome. In such a case, the clear dome is usually an epoxy dome. In the preferred embodiment, the flat surface is circular and is sunken into the top surface of the clear domed cover that covers the face of the clock.

### BRIEF DESCRIPTION OF THE DRAWINGS

The above and other objects and advantages of the present invention will be apparent upon consideration of the following detailed description, taken in conjunction with the accompanying drawings, in which reference characters refer to like parts throughout, and in which:

FIG. 1 shows the present invention without a label; and

FIG. 2 shows the present invention with a label.

### DETAILED DESCRIPTION OF THE INVENTION

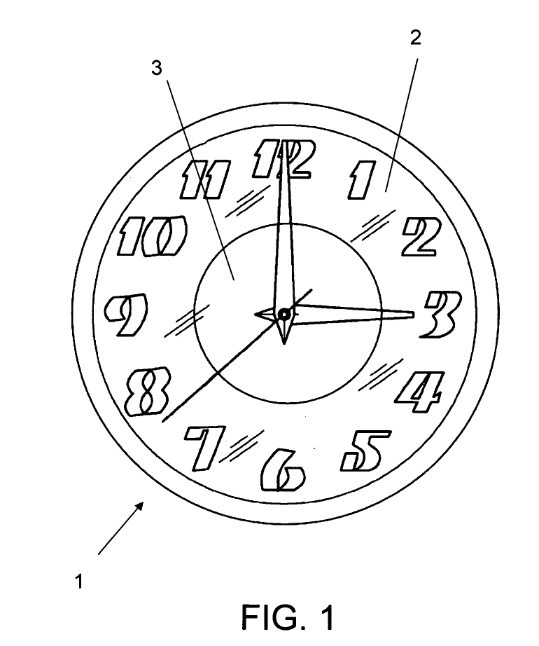

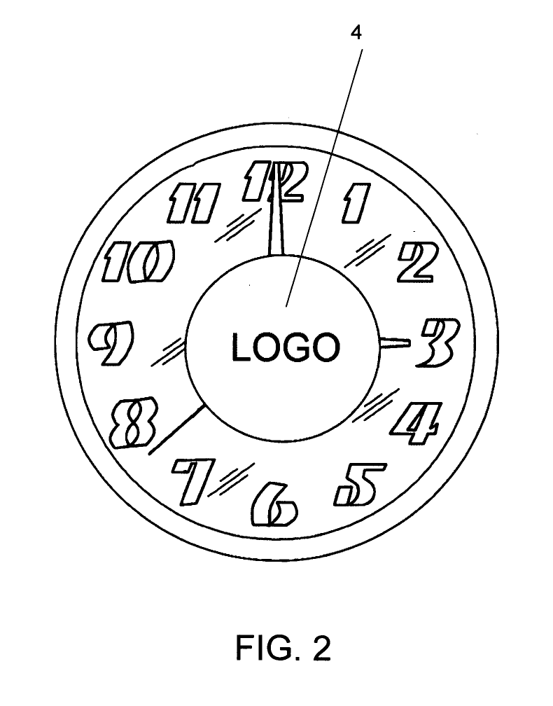

FIG. 1 shows the present invention. A wall clock 1 includes a clock face and a clear domed cover 2 over the clock face, wherein the clear domed cover has a flat surface 3 at the center to serve as a branding area. As seen in FIG. 2, a label 4 is applied to the clear domed cover so that substantially all of said flat surface is covered. In the preferred embodiment, the label is itself covered by a clear dome, such as a clear epoxy dome.

In the preferred embodiment, the flat surface of the clear domed cover 2 that covers the clock face is circular. It is preferred that the flat surface is sunken into the top surface of the clear domed cover 2 that covers the face of the clock.

In the preferred embodiment, the depth of the branding area is about 1 mm. Typically, the branding area is substantially circular. Advertising, trademarks and other product or company information can be imprinted or otherwise marked on the front branding area. In the preferred embodiment, the sunken surface is configured to accept adhesive labels that bear the desired branding. Viewing the preferred embodiment from the front, the product is about 10″ is diameter. The face of the clock is about 8½″ in diameter. The diameter of the branding area is about 4½″ in diameter. In the preferred embodiment, the area covered by the face of the clock is about 57 square inches, while the area of the branding area is about 16 square inches. It is preferred that the branding area be at least 20% of the area covered by the face of the clock. More preferrably, the branding area is at least 25% of the area covered by the clock. It is preferred that both the face of the clock and the branding area are circular. However, the branding area can be of another shape, such as an oval or rectangle.

One of ordinary skill in the art will appreciate that the techniques, structures and methods of the present invention above are exemplary. The present invention can be implemented in various embodiments without deviating from the scope of the invention.

1. A wall clock comprising: a clock face; a clear domed cover over the clock face, said clear domed cover comprising a flat surface at the center to serve as a branding area.

2. The wall clock of claim 1, further comprising a label covering substantially all of said flat surface.

3. The wall clock of claim 2, wherein the label is itself covered by a clear dome.

4. The wall clock of claim 3, wherein the clear dome covering the label is an epoxy dome.

5. The wall clock of claim 1, wherein said flat surface is circular.

6. The wall clock of claim 1, wherein said flat surface is sunken into the top surface of the clear domed cover that covers the face of the clock.

7. The wall clock of claim 1, wherein said flat surface comprises more than 25% of the top surface of the clear domed cover that covers the face of the clock.
